(19) United States
(12) Patent Application Publication
(10) Pub. No.: US 2023/0170129 A1
(43) Pub. Date: Jun. 1, 2023

(54) COIL COMPONENT

(71) Applicant: Murata Manufacturing Co., Ltd., Kyoto-fu (JP)

(72) Inventors: Tarou TSUJIBAYASHI, Nagaokakyo-shi (JP); Masashi MIYAMOTO, Nagaokakyo-shi (JP)

(73) Assignee: Murata Manufacturing Co., Ltd., Kyoto-fu (JP)

(21) Appl. No.: 18/056,408

(22) Filed: Nov. 17, 2022

(30) Foreign Application Priority Data
Dec. 1, 2021 (JP) 2021-195290

(51) Int. Cl. H01F 27/26; H01F 27/29

(52) U.S. Cl. CPC H01F 27/266; H01F 27/29

(57) ABSTRACT

A coil component includes a core having first and second flange portions, and a top plate. Convex first and second spacer portions are in a lower main surface of the top plate that faces the first and second flange portions and are in contact with top surfaces of the first and second flange portions to form gaps between the top surfaces of the flange portions and the lower main surface of the top plate. A stage portion is in a region of the lower main surface of the top plate that faces the winding core portion of the core, and the first and second spacer portions are connected to each other via the stage portion. The spacer portions and the stage portion form a convex portion having a relatively large area to prevent the spacer portions from being scraped and damaged in a polishing process for deburring or chamfering.

### CROSS-REFERENCE TO RELATED APPLICATION

This application claims benefit of priority to Japanese Patent Application No. 2021-195290, filed Dec. 1, 2021, the entire content of which is incorporated herein by reference.

### BACKGROUND

### Technical Field

The present disclosure relates to a coil component that includes a core including a winding core portion around which a wire is wound and a first flange portion and a second flange portion that are provided in both end portions of the winding core portion and includes a top plate fixed to the core while being disposed between the first flange portion and the second flange portion, and relates more particularly to the shape of the top plate.

### Background Art

For example, Japanese Unexamined Patent Application Publication No. 2018-107248 describes a coil component including a drum core, made of a magnetic material, that includes a winding core portion around which a wire is wound and a first flange portion and a second flange portion that are provided in the end portions of the winding core portion and includes a top plate, made of a magnetic material, that is fixed to the core while being disposed between the first flange portion and the second flange portion.

Each of the first flange portion and the second flange portion has a mounting surface facing a mounting board in a mounted state and a top surface facing away from the mounting surface. The top plate is fixed to the core via an adhesive with the lower main surface thereof facing the top surfaces of the first flange portion and the second flange portion.

Gaps are provided between the top surfaces of the first flange portion and the second flange portion and the lower main surface of the top plate to make magnetic saturation less likely to occur, thereby improving the DC superimposition characteristics. To provide such gaps, a plurality of projections in contact with each of the top surfaces of the first flange portion and the second flange portion are provided, for example, in the regions of the lower main surface of the top plate that face the first flange portion and the second flange portion.

### SUMMARY

The core and the top plate described above are manufactured, for example, by press-molding ferrite powder by using a metal mold and firing the resulting molded body. After firing, barrel polishing is performed to remove burrs generated during molding. At this time, the corners of the ridgelines of the core and the top plate are removed to obtain small round-chamfered shapes.

However, at least some portions of the projections may be undesirably scraped in the barrel polishing process depending on the polishing conditions. This causes fluctuations in the characteristics of the coil component, which results in inexpedience that does not enable a desired inductance value to be stably obtained.

Accordingly, the present disclosure provides the coil component in which the gaps between the top plates and the core can be stably formed.

A coil component according to the present disclosure includes a core including a winding core portion extending in an axial direction, a first flange portion, and a second flange portion, the first flange portion and the second flange portion being provided in both end portions in the axial direction of the winding core portion, the core being made of a first magnetic material; a top plate having a lower main surface and an upper main surface that face away from each other, the top plate being made of a second magnetic material; and at least one wire wound around the winding core. The first magnetic material may be identical to or different from the second magnetic material.

Each of the first flange portion and the second flange portion has a mounting surface facing a mounting board in a mounted state and a top surface facing away from the mounting surface. The top plate is fixed to the core via an adhesive with the lower main surface facing the top surfaces of the first flange portion and the second flange portion.

A convex first spacer portion in contact with the top surface is provided in part of a region of the lower main surface of the top plate, the region facing the first flange portion.

A convex second spacer portion in contact with the top surface is provided in part of a region of the lower main surface of the top plate, the region facing the second flange portion.

The present disclosure has the convex stage portion in the region of the lower main surface of the top plate that faces the winding core portion, and the first spacer portion and the second spacer portion are connected to each other via the stage portion in view of the technical problem described above.

Since the first spacer portion and the second spacer portion for forming gaps between the top surfaces of the first flange portion and the second flange portion of and the lower main surface of the top plate are connected to each other via the stage portion, the first spacer portion, the second spacer portion, and the stage portion form the convex portion having a relatively large area. Accordingly, the first spacer portion and the second spacer portion can be prevented from being scraped and damaged even in a polishing process for deburring or chamfering, thereby enabling stable electric characteristics such as a desired inductance value to be obtained.

Since the convex stage portion of the top plate is thick in the present disclosure, mechanical strength such as the bending strength of the top plate can be increased. In addition, since the stage portion is provided in the region of the lower main surface of the top plate that faces the winding core portion, the size of the coil component as a product does not increase. The mechanical strength described above is required when, for example, the coil component is mounted by a mounter.

### BRIEF DESCRIPTION OF THE DRAWINGS

FIG. 1 is a front view illustrating the appearance of a coil component according to a first embodiment of the present disclosure;

FIG. 2 is a left-side view illustrating the appearance of the coil component illustrated in FIG. 1;

FIG. 3 is a perspective view illustrating the appearance of the coil component illustrated in FIG. 1 in which a wire is not illustrated;

FIG. 4 is a perspective view illustrating only a top plate of the coil component illustrated in FIG. 1 as seen from the side of a lower main surface;

FIG. 5 is a sectional view taken along line A-A in FIG. 1;

FIG. 6 is a perspective view illustrating only the top plate of the coil component according to a second embodiment of the present disclosure as seen from the side of the lower main surface;

FIG. 7 is a sectional view corresponding to FIG. 5 of the coil component having the top plate illustrated in FIG. 6;

FIG. 8 is a perspective view illustrating only the top plate of the coil component according to a third embodiment of the present disclosure as seen from the side of the lower main surface; and

FIG. 9 is a perspective view illustrating only the top plate of the coil component according to a fourth embodiment of the present disclosure as seen from the side of the lower main surface.

### DETAILED DESCRIPTION

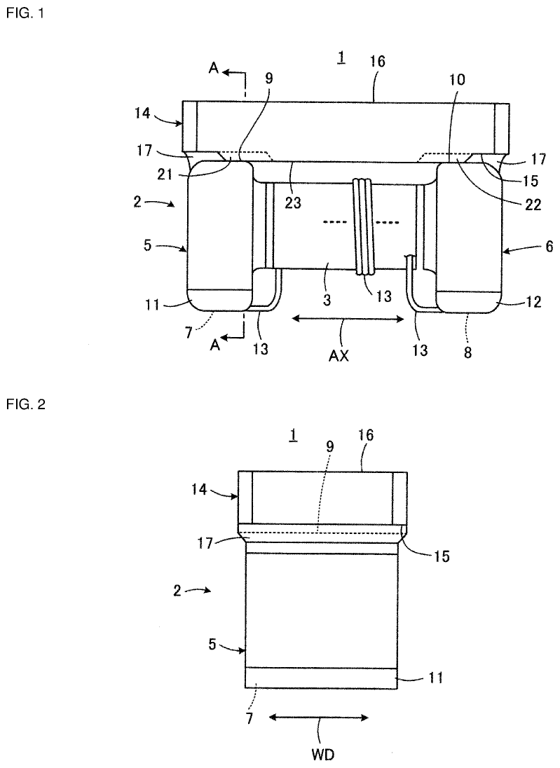

A coil component 1 according to a first embodiment of the present disclosure will be described with reference to FIGS. 1 to 5.

The coil component 1 has a core 2 made of a magnetic material such as Ni—Zn ferrite or other ferrite or a resin containing ferrite powder or metal magnetic powder. The core 2 includes a winding core portion 3 extending in an axial direction AX, and a first flange portion 5 and a second flange portion 6 that are provided in both end portions in the axial direction AX of the winding core portion 3. The winding core portion 3 has, for example, a rectangular cross-sectional shape, but may have a polygonal shape such as a hexagonal shape, a circular shape, an elliptical shape, or a shape obtained by combining these shapes.

The first flange portion 5 and the second flange portion 6 have the mounting surfaces 7 and 8 that face a mounting board, which is not illustrated, and top surfaces 9 and 10 that face away from the mounting surfaces 7 and 8, respectively.

A first terminal electrode 11 is provided on the mounting surface 7 of the first flange portion, and a second terminal electrode 12 is provided on the mounting surface 8 of the second flange portion 6. The terminal electrodes 11 and 12 are formed by infiltration or printing of a conductive paste containing conductive metal powder such as Ag powder, baking the conductive paste, and then performing Cu plating, Ni plating, and Sn plating in sequence. Alternatively, the terminal electrodes 11 and 12 may be provided by attaching terminal members made from conductive metal plates to the first and second flange portions 5 and 6.

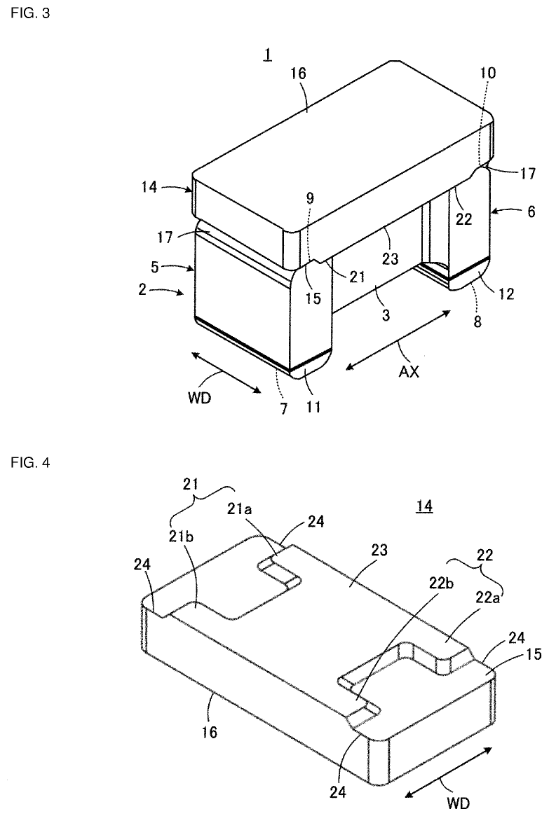

At least one wire 13 is wound around the winding core portion 3, as illustrated in FIG. 1. It should be noted that the wire 13 is not illustrated in FIG. 3. The wire 13 includes a core wire made of a highly conductive metal, such as copper, silver, or gold, and an electrically insulating film made of an electrically insulating resin, such as polyamideimide, polyurethane, or polyesterimide, that covers the core wire. The core wire has a diameter of, for example, not less than 40 μm and not more than 200 μm (i.e., from 40 μm to 200 μm).

A first end of the wire 13 is connected to the first terminal electrode 11 near the mounting surface 7 of the first flange portion 5 and a second end is connected to the second terminal electrode 12 near the mounting surface 8 of the second flange portion 6. Since an end portion of the wire 13 does not need to be located in a joint between the core 2 and the top plate 14 in this structure, the core 2 and the top plate 14 can be designed regardless of the presence of the wire 13. For example, the wire 13 does not limit the positions and shapes of spacer portions 21 and 22, which will be described later.

The terminal electrodes 11 and 12 are connected to the wire 13 by thermal pressure bonding, ultrasonic welding, laser welding, or the like. The number of turns of the wire 13 around the winding core portion 3 is selected arbitrarily depending on the required characteristics. The wire 13 may be wound in a plurality of layers as needed.

The coil component 1 has the top plate 14 provided between the first flange portion 5 and the second flange portion 6 described above. The top plate 14 has the lower main surface 15 and an upper main surface 16 that face away from each other. The top plate 14 is made of a magnetic material such as ferrite or a resin containing ferrite powder or metal magnetic powder. When both the core 2 and the top plate 14 are made of the magnetic material as described above, the top plate 14 forms a closed magnetic circuit together with the core 2.

The top plate 14 is fixed to the core 2 via the adhesive 17 with the lower main surface 15 thereof facing the top surface 9 of the first flange portion 5 and the top surface 10 of the second flange portion 6. The adhesive 17 includes thermosetting resins such as epoxy resins. Inorganic fillers such as silica fillers may be added to the adhesive 17 to improve thermal shock resistance.

For example, the coil component 1 has a dimension in the longitudinal direction (axial direction AX) of 1.6 mm, a dimension in the width direction (direction orthogonal to the axial direction AX and parallel to the mounting surface) of 0.8 mm, and a dimension in the height direction (direction orthogonal to the axial direction AX and the width direction) of 1.1 mm Since a reduction in the mechanical strength of the top plate 14 can be suppressed in the present disclosure, the present disclosure exerts a greater effect particularly in a small product having a thin top plate 14. However, the present disclosure does not limit the product dimensions.

The coil component 1 is preferably manufactured by, for example, the following process.

First, the core 2 and the top plate 14 are prepared. When the core 2 and the top plate 14 are manufactured, for example, ferrite powder is press-molded with a metal mold and the obtained molded body is fired to obtain the sintered body to be the core 2 and the sintered body to be the top plate 14. Then, the sintered body to be the core 2 and the sintered body to be the top plate 14 undergo barrel polishing to remove burrs, thereby obtaining the core 2 and the top plate 14. The corners of the ridgelines of the core 2 and the top plate 14 are removed to perform small round-chamfering.

Next, to provide the terminal electrodes 11 and 12 on the core 2, a conductive paste containing, for example, Ag is applied to the mounting surfaces 7 and 8 of the first flange portion 5 and the second flange portion 6, the conductive paste is baked, and Cu plating, Ni plating, and Sn plating are then performed in sequence by using the electrolytic barrel plating method.

The wire 13 is wound around the winding core portion 3 of the core 2 by use of, for example, a nozzle, and the first end and the second end of the wire 13 are connected to the first terminal electrode 11 and the second terminal electrode 12, respectively. Here, the wire 13 and the terminal electrodes 11 and 12 are connected to each other by, for example, thermal pressure bonding using a heater chip. The excess portions of the wire 13 connected to the terminal electrodes 11 and 12 are cut by a cutting blade and then removed.

Next, the top plate 14 is disposed on the core 2 via the adhesive 17, and the top plate 14 and the core 2 are fixed to each other.

The coil component 1 is formed completely as described above.

The coil component 1 has the following characteristics with respect to the top plate 14.

As is well illustrated in FIG. 4, the regions of the lower main surface 15 of the top plate 14 that face the first flange portion 5 and the second flange portion 6 are provided with a convex first spacer portion 21 and a convex second spacer portion 22 in contact with parts of the top surfaces 9 and 10, respectively. It should be noted that a thin film of the adhesive 17 may be present between the first and second spacer portions 21 and 22 and the top surfaces 9 and 10. The spacer portions 21 and 22 form gaps between the top surfaces 9 and 10 of the first and second flange portions 5 and 6 and the lower main surface 15 of the top plate 14. The dimensions in the height direction of the first spacer portion 21 and the second spacer portion 22 from the lower main surface 15, that is, the dimensions of the gaps are set to, for example, not less than 20 μm and not more than 70 μm (i.e., from 20 μm to 70 μm).

In the embodiment, when a width direction WD is the direction in which the lower main surface 15 extends and which is orthogonal to the axial direction AX, the first spacer portion 21 is divided into two portions 21a and 21b arranged in the width direction, and the second spacer portion 22 is divided into two portions 22a and 22b arranged in the width direction. This reduces the contact area between the spacer portions 21 and 22 and the flange portions 5 and 6 to reduce the chance of magnetic saturation occurring and enables the posture of the top plate 14 to be stabilized with respect to the core 2.

In addition, a convex stage portion 23 as a thick portion is provided in a region of the lower main surface 15 of the top plate 14 that faces the winding core portion 3. The first spacer portion 21 and the second spacer portion 22 are connected to each other via the stage portion 23. As a result, the first spacer portion 21, the second spacer portion 22, and the stage portion 23 form a planar H-shape.

As described above, the first spacer portion 21, the second spacer portion 22, and the stage portion 23 form a convex portion having a relatively large area. Accordingly, the first spacer portion 21 and the second spacer portion 22 can be prevented from being scraped and damaged even in a barrel polishing process for deburring or chamfering, thereby enabling effects on the electric characteristics to be reduced.

In addition, since the top plate 14 has the convex stage portion 23 as a thick portion, the mechanical strength such as the bending strength of the top plate 14 can be increased. In addition, since the stage portion 23 is provided in a region that does not project to the outside, such as the region facing the winding core portion 3 in the lower main surface 15 of the top plate 14, the size of the coil component 1 as a product does not increase.

In addition, since the first spacer portion 21, the second spacer portion 22, and the stage portion 23 form a planar H-shape as described above, the stable application shape of the adhesive 17 can be obtained by applying the adhesive 17 to the space partitioned by the portions 21a and 21b of the first spacer portion 21 and the stage portion 23 and the space partitioned by the portions 22a and 22b of the second spacer portion 22 and the stage portion 23.

In the embodiment, the following characteristics can also be found.

The dimension in the width direction WD of the stage portion 23 is larger than the dimension in the width direction WD of the first spacer portion 21 and the dimension in the width direction WD of the second spacer portion 22. Here, the dimension in the width direction WD of the first spacer portion 21 is the sum of the dimension in the width direction WD of the portion 21a and the dimension in the width direction WD of the portion 21b, and the dimension in the width direction WD of the second spacer portion 22 is the sum of the dimension in the width direction WD of the portion 22a and the dimension in the width direction WD of the portion 22b. This structure can further produce the effect of the thick stage portion 23 on improving the bending strength of the top plate 14.

When the dimension measured in the direction parallel to the axial direction AX is the dimension in the longitudinal direction, the dimension in the longitudinal direction of the stage portion 23 is smaller than the dimension in the longitudinal direction of the winding core portion 3, and the stage portion 23 is away from the first flange portion 5 and the second flange portion 6. These can be inferred from the outline of the stage portion 23 illustrated by the dashed line in FIG. 1. In this structure, since the stage portion 23 does not contribute to the formation of a magnetic flux circuit, the mechanical strength can be increased without impairing the effect of improving the DC superimposition characteristics. The effect is obtained with greater certainty when the distance between the first and second flange portions 5 and 6 and the stage portion 23 is larger than the distance between the flange portions 5 and 6 and the top plate 14 due to the spacer portions 21 and 22 described above.

Regarding the dimension in the height direction measured from the lower main surface 15 of the top plate 14, the dimension in the height direction of the stage portion 23 is equal to the dimensions in the height direction of the first spacer portion 21 and the second spacer portion 22. In this structure, no steps are present between the first and second spacer portions 21 and 22 and the stage portion 23. Since stress may be concentrated on a step, the mechanical strength of the top plate 14 can be further increased by preventing the generation of a step.

In addition, focusing on the stage portion 23, the stage portion 23 extends continuously in the width direction WD. When the stage portion is provided at a plurality of locations in the width direction WD, steps are generated between the stage portion and the lower main surface 15 of the top plate 14. However, no steps are generated when the stage portion extends continuously. Accordingly, since there are no portions on which stress due to steps is concentrated, the mechanical strength of the top plate 14 is not reduced.

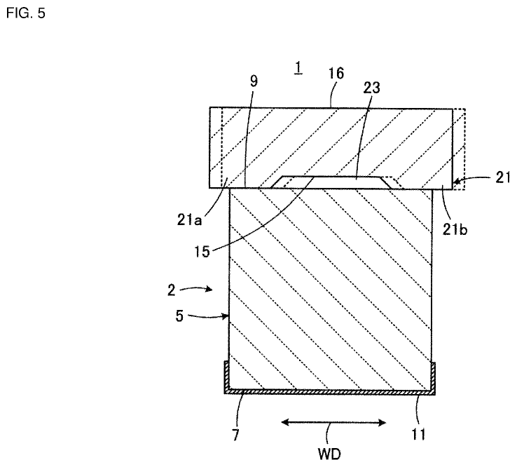

As illustrated in FIGS. 2 and 5, the dimension in the width direction WD of the top plate 14 is larger than the dimensions in the width direction WD of the flange portions 5 and 6 of the core 2. In addition to this structure, when the direction parallel to the axial direction AX is the longitudinal direction, the lower main surface 15 of the top plate 14 has sides 24 (see FIG. 4) extending in the longitudinal direction, and the first spacer portion 21 and the second spacer portion 22 are located in contact with the sides 24 extending in the longitudinal direction. It should be noted that the adhesive 17 is not illustrated in FIG. 5.

In the situation described above, as well illustrated in FIG. 5, the following conditions are met: both edges in the width direction WD of the top surface 9 of the first flange portion 5 are present at positions facing intermediate portions in the width direction WD of the first spacer portion 21, and both edges in the width direction WD of the top surface 10 of the second flange portion 6 are present at positions facing intermediate portions in the width direction WD of the second spacer portion 22.

In the structure as described above, even if the position of the top plate 14 with respect to the core 2 slightly deviates in the width direction WD as indicated by the dashed lines in FIG. 5, the contact area between the lower main surface 15 of the top plate 14 and the top surfaces 9 and 10 of the flange portions 5 and 6 can be kept constant. Accordingly, even if the position of the top plate 14 with respect to the core 2 deviates, the magnetic properties do not change substantially.

As illustrated in FIGS. 1 and 3, the first spacer portion 21 faces a region of the top surface 9 of the first flange portion 5 close to the winding core portion 3, and the second spacer portion 22 faces a region of the top surface 10 of the second flange portion 6 close to the winding core portion 2. For example, the first spacer portion 21 overlaps the top surface 9 in the region of ⅓ to ½ the length in the axial direction AX of the top surface 9, and the second spacer portion 22 overlaps the top surface 10 in the region of ⅓ to ½ the length in the axial direction AX of the top surface 10. This structure reduces the contact areas between the spacer portions 21 and 22 and the flange portions 5 and 6 to reduce the chance of magnetic saturation occurring. In addition, since the contact portions between the spacer portions 21 and 22 and the top surfaces 9 and 10 are close to the winding core portion 3 in this structure, the closed magnetic circuit formed by the core 2 and the top plate 14 can be shorter, thereby reducing the magnetic resistance.

The rising surfaces of the peripheral edges of the circumferential edges of the first spacer portion 21, the second spacer portion 22, and the stage portion 23 from the lower main surface are inclined surfaces. This structure can disperse stress, contributes to improving mechanical strength, and facilitates the molding of the top plate 14 by using a metal mold.

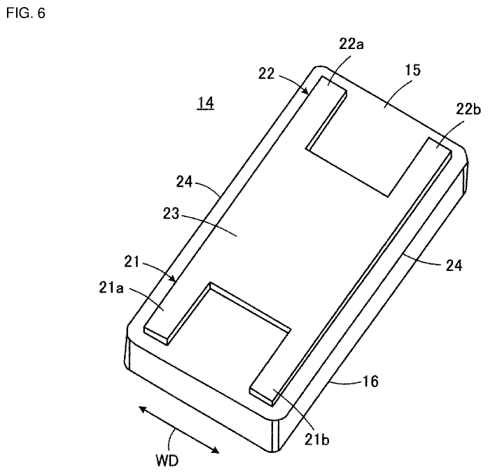

Next, other embodiments of the present disclosure will be described with reference to FIG. 6 and subsequent figures. In FIG. 6 and subsequent figures, components corresponding to those illustrated in FIGS. 1 to 5 are denoted by the same reference numerals and description thereof is omitted. Description of the other embodiments covers only the parts that are substantially different or characteristic compared with the embodiment illustrated in FIGS. 1 to 5.

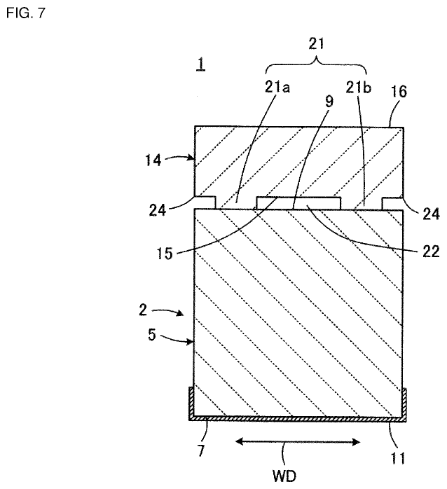

Referring to FIGS. 6 and 7, in the second embodiment, the first spacer portion 21 and the second spacer portion 22 are located away from the sides 24 extending in the longitudinal direction of the lower main surface 15 of the top plate 14. Similarly, the stage portion 23 is also located away from the sides 24 extending in the longitudinal direction of the lower main surface 15 of the top plate 14. This structure further prevents the first spacer portion 21, the second spacer portion 22, and the stage portion 23 from being scraped and damaged in the barrel polishing process for deburring or chamfering of the top plate 14.

In addition to the structure described above, in the second embodiment, as illustrated in FIG. 7, both edges in the width direction WD of the top surface 9 of the first flange portion 5 are present at positions facing a position outward in the width direction WD of the first spacer portion 21, and both edges in the width direction WD of the top surface 10 of the second flange portion 6 are present at a position outward in the width direction WD of the second spacer portion 22.

In this structure, even when the dimension in the width direction WD of the top plate 14 is equal to the dimension in the width directions WD of the flange portions 5 and 6 of the core 2 as can be seen in FIG. 7, the change in the magnetic properties can be reduced even if the position of the top plate 14 with respect to the core 2 slightly deviates in the width direction WD.

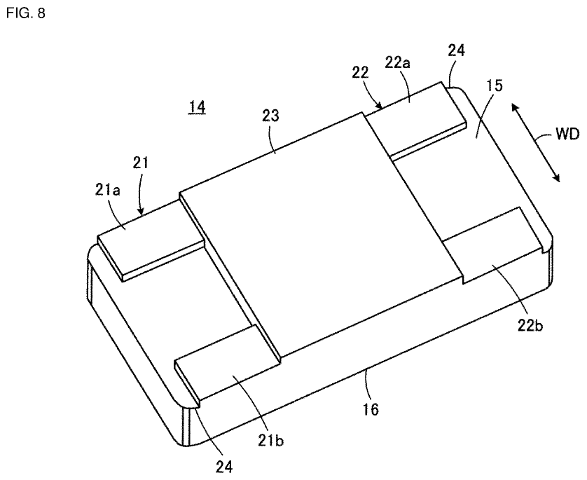

Referring to FIG. 8, in the third embodiment, the dimension in the height direction of the stage portion 23, which is measured from the lower main surface 15 of the top plate 14, is larger than the dimensions in the height direction of the first spacer portion and the second spacer portion. This structure can further increase the mechanical strength such as the bending strength of the top plate 14.

Here, it should be also noted that the stage portion 23 is provided in a region that does not project to the outside, such as a region facing the winding core portion of the lower main surface 15 of the top plate 14. In this case, even if the dimension in the height direction of the stage portion 23 is enlarged, the stage portion 23 only approaches the winding core portion and the size of the coil component 1 as a product does not increase.

The third embodiment described above is particularly effective in that the dimension in the longitudinal direction of the stage portion 23 is smaller than the dimension in the longitudinal direction of the winding core portion and the stage portion 23 is away from the first flange portion and the second flange portion as described in the first embodiment to increase the mechanical strength without impairing the effect of improving the DC superimposition characteristics. This is because as the dimension in the height direction of the stage portion 23 is larger, the first flange portion and the second flange portion becomes closer to the stage portion 23 and the effect of improving the DC superimposition characteristics becomes smaller.

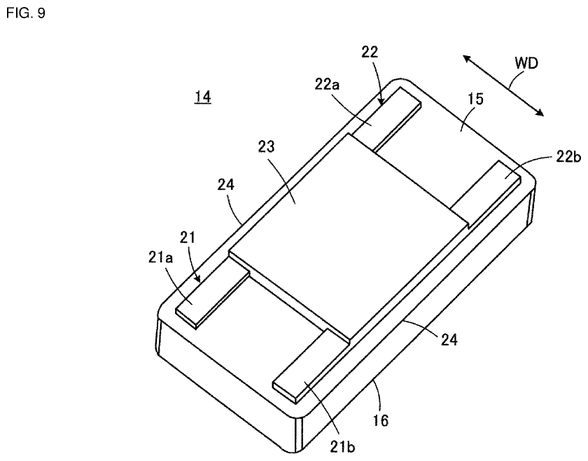

Referring to FIG. 9, the fourth embodiment has the feature of the third embodiment, that is, the dimension in the height direction of the stage portion 23 is larger than the dimensions in the height direction of the first spacer portion 21 and the second spacer portion 22 as well as the feature of the second embodiment, that is, the first spacer portion 21, and the second spacer portion 22, and the stage portion 23 are located away from the sides 24 extending in the longitudinal direction of the lower main surface 15 of the top plate 14.

Although the present disclosure has been described in relation to the illustrated embodiments, various other modifications can be made within the scope of the present disclosure.

For example, the coil component to which the present disclosure is applied may be a coil component constituting a common mode choke coil or a coil component constituting a transformer or balun in addition to the coil component constituting a single coil. Therefore, the number of wires is changed in accordance with the function of a coil component, and the number of the terminal electrodes provided in the flange portions can also be changed accordingly.

In addition, in configuring the coil component according to the present disclosure, the structures of different embodiments described in this specification can be partially replaced or combined.

What is claimed is:

1. A coil component comprising:
a core including a winding core portion extending in an axial direction, a first flange portion, and a second flange portion, the first flange portion and the second flange portion being at both end portions in the axial direction of the winding core portion, and the core including a first magnetic material;
a top plate having a lower main surface and an upper main surface that face away from each other, the top plate including a second magnetic material; and
at least one wire wound around the winding core portion,
wherein
each of the first flange portion and the second flange portion has a mounting surface facing a mounting board in a mounted state and a top surface facing away from the mounting surface,
the top plate is fixed to the core via an adhesive with the lower main surface facing the top surface of the first flange portion and the top surface of the second flange portion,
a convex first spacer portion in contact with the top surface is in part of a region of the lower main surface, the region facing the first flange portion,
a convex second spacer portion in contact with the top surface is in part of a region of the lower main surface, the region facing the second flange portion,
a convex stage portion is in a region of the lower main surface, the region facing the winding core portion, and
the first spacer portion and the second spacer portion are connected to each other via the stage portion.

2. The coil component according to claim 1, wherein
a dimension in a width direction of the stage portion is larger than a direction in the width direction of the first spacer portion and a dimension in the width direction of the second spacer portion, the width direction being a direction in which the lower main surface extends and which is orthogonal to the axial direction.

3. The coil component according to claim 1, wherein
a dimension in the longitudinal direction of a portion of the stage portion facing the winding core portion is smaller than a dimension in the longitudinal direction of the winding core portion, and the stage portion is away from the first flange portion and the second flange portion, the longitudinal direction being parallel to the axial direction.

4. The coil component according to claim 3, wherein
a dimension in a height direction of the stage portion measured from the lower main surface is equal to dimensions in the height direction of the first spacer portion and the second spacer portion that are measured from the lower main surface.

5. The coil component according to claim 3, wherein
a dimension in a height direction of the stage portion measured from the lower main surface is larger than dimensions in the height direction of the first spacer portion and the second spacer portion that are measured from the lower main surface.

6. The coil component according to claim 1, wherein
the first spacer portion is divided into two portions in the width direction, and the second spacer portion is divided into two portions in the width direction, the width direction being a direction in which the lower main surface extends and which is orthogonal to the axial direction.

7. The coil component according to claim 1, wherein
the lower main surface has a side extending in the longitudinal direction, the longitudinal direction being parallel to the axial direction, and the first spacer portion and the second spacer portion are in contact with the side extending in the longitudinal direction.

8. The coil component according to claim 1, wherein
the lower main surface has a side extending in the longitudinal direction, the longitudinal direction being parallel to the axial direction, and the first spacer portion and the second spacer portion are away from the side extending in the longitudinal direction.

9. The coil component according to claim 1, wherein
both edges in the width direction of the top surface of the first flange portion are present at positions facing intermediate portions in the width direction of the first spacer portion, and both edges in the width direction of the top surface of the second flange portion are present at positions facing intermediate portions in the width direction of the second spacer portion, the width direction being a direction in which the lower main surface extends and which is orthogonal to the axial direction.

10. The coil component according to claim 1, wherein
both edges in the width direction of the top surface of the first flange portion are present at positions facing a position outward in the width direction of the first spacer portion, and both edges in the width direction of the top surface of the second flange portion are present at positions facing a position outward in the width direction of the second spacer portion, the width direction being a direction in which the lower main surface extends and which is orthogonal to the axial direction.

11. The coil component according to claim 1, wherein
the first spacer portion faces a region of the top surface of the first flange portion, the region being close to the winding core portion, and the second spacer portion faces a region of the top surface of the second flange portion, the region being close to the winding core portion.

12. The coil component according to claim 1, wherein
rising surfaces of peripheral edges of the first spacer portion, the second spacer portion, and the stage portion from the lower main surface are inclined surfaces.

13. The coil component according to claim 1, further comprising:
a terminal electrode on the mounting surface,
wherein the wire is connected to the terminal electrode on a side of the mounting surface.

14. The coil component according to claim 2, wherein
a dimension in the longitudinal direction of a portion of the stage portion facing the winding core portion is smaller than a dimension in the longitudinal direction of the winding core portion, and the stage portion is away from the first flange portion and the second flange portion, the longitudinal direction being parallel to the axial direction.

15. The coil component according to claim 2, wherein
the first spacer portion is divided into two portions in the width direction, and the second spacer portion is divided into two portions in the width direction, the width direction being a direction in which the lower main surface extends and which is orthogonal to the axial direction.

16. The coil component according to claim 2, wherein
the lower main surface has a side extending in the longitudinal direction, the longitudinal direction being parallel to the axial direction, and the first spacer portion and the second spacer portion are in contact with the side extending in the longitudinal direction.

17. The coil component according to claim 2, wherein
the lower main surface has a side extending in the longitudinal direction, the longitudinal direction being parallel to the axial direction, and the first spacer portion and the second spacer portion are away from the side extending in the longitudinal direction.

18. The coil component according to claim 2, wherein
both edges in the width direction of the top surface of the first flange portion are present at positions facing intermediate portions in the width direction of the first spacer portion, and both edges in the width direction of the top surface of the second flange portion are present at positions facing intermediate portions in the width direction of the second spacer portion, the width direction being a direction in which the lower main surface extends and which is orthogonal to the axial direction.

19. The coil component according to claim 2, wherein
both edges in the width direction of the top surface of the first flange portion are present at positions facing a position outward in the width direction of the first spacer portion, and both edges in the width direction of the top surface of the second flange portion are present at positions facing a position outward in the width direction of the second spacer portion, the width direction being a direction in which the lower main surface extends and which is orthogonal to the axial direction.

20. The coil component according to claim 2, wherein
the first spacer portion faces a region of the top surface of the first flange portion, the region being close to the winding core portion, and the second spacer portion faces a region of the top surface of the second flange portion, the region being close to the winding core portion.
